(19) United States
(12) Patent Application Publication
(10) Pub. No.: US 2015/0362847 A1
(43) Pub. Date: Dec. 17, 2015

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Masato Tanaka, Tagata-gun (JP); Masataka Kawahara, Mishima-shi (JP); Jumpei Kuno, Mishima-shi (JP); Tsutomu Nishida, Mishima-shi (JP); Kaname Watariguchi, Yokohama-shi (JP)

(21) Appl. No.: 14/730,482

(22) Filed: Jun. 4, 2015

(30) Foreign Application Priority Data
Jun. 13, 2014 (JP) 2014-122841
Nov. 28, 2014 (JP) 2014-241841

(51) Int. Cl. G03G 15/00

(52) U.S. Cl. CPC G03G 5/047; G03G 5/0618; G03G 5/0696; G03G 5/0609

(57) ABSTRACT

The present invention can provide an electrophotographic photosensitive member that is capable of suppressing potential variation as much as possible to allow a high-quality image to be output, as well as a process cartridge and an electrophotographic apparatus including the electrophotographic photosensitive member. Therefore, the electrophotographic photosensitive member of the present invention is an electrophotographic photosensitive member comprising: a support; a charge-generating layer; and a charge-transporting layer on the charge-generating layer, in which the charge-generating layer comprises a gallium phthalocyanine crystal in which a polar solvent is contained, and the polar solvent is at least one selected from dimethylsulfoxide, N,N-dimethylformamide, N-methylformamide, N-propylformamide, N-vinylformamide and N-methylpyrrolidone relative to gallium phthalocyanine, and the content of the polar solvent is 0.1% by mass or more and 2.0% by mass or less based on a gallium phthalocyanine in the gallium phthalocyanine crystal, and the charge-transporting layer contains a compound represented by formula (1).

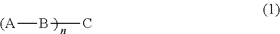

### BACKGROUND OF THE INVENTION

1. Field of the Invention

The present invention relates to an electrophotographic photosensitive member, and a process cartridge and an electrophotographic apparatus including the electrophotographic photosensitive member.

2. Description of the Related Art

Currently, an electrophotographic photosensitive member is generally an electrophotographic photosensitive member having a functional separation type laminated structure in which a photosensitive layer is provided on a support and the photosensitive layer has a charge-generating function (charge-generating layer) and a charge-transporting function (charge-transporting layer) shared in respective separate substances (layers).

With respect to a charge-generating material having the charge-generating function, the emission wavelength of a semiconductor laser commonly used as an image exposing unit is as long as from 650 to 820 nm, and therefore a charge-generating material having a high sensitivity to light of a long wavelength is developed in progress.

A phthalocyanine pigment is effective as such a charge-generating substance having a high sensitivity to light up to a long wavelength region, and in particular, oxytitanium phthalocyanine and gallium phthalocyanine, having excellent sensitive characteristics, have been heretofore reported with respect to various crystal forms and improved production methods.

Japanese Patent Application Laid-Open No. H07-331107 discloses a hydroxygallium phthalocyanine crystal containing a polar organic solvent. A polar organic solvent such as N,N-dimethylformamide is used for a conversion solvent to thereby allow the polar organic solvent to be incorporated in the crystal, providing a crystal having excellent sensitive characteristics. On the contrary, however, a problem is that a photocarrier produced easily remains in a photosensitive layer and easily causes potential variation as one memory.

On the other hand, the charge-transporting layer sharing the charge-transporting function is demanded to have the charge-transporting function, and further to have characteristics of high mechanical strength and less degradation of discharge in the case of being located on the outermost surface of the electrophotographic photosensitive member. The charge-transporting layer is formed using a resin, and therefore a charge-transporting material having high mobility and a resin having a strong mechanical strength and having resistance to discharge are developed in progress.

In particular, the charge-transporting layer may be made thinner due to abrading in repeated use, thereby resulting in potential variation due to the change in capacity of the photosensitive member. Moreover, the charge-generating material, the charge-transporting material and the resin may be degraded due to discharge, thereby resulting in potential variation.

Japanese Patent Application Laid-Open No. 2007-279446 and International Publication No. WO 2011/108064 report the following: an additive having gas resistance is added to thereby suppress potential variation.

It is also known to add, to the charge-transporting layer, a release agent for the purpose of an increase in transfer efficiency of a toner, a filler for the purpose of prevention of abrading, and a lubricant for the purpose of an increase in lubricating property of the surface of the electrophotographic photosensitive member. Japanese Patent Application Laid-Open No. 2013-238667, however, reports the following: such additives may be added to thereby increase potential variation.

As described above, various improvements have been tried with respect to the electrophotographic photosensitive member. In particular, further improvements in characteristics associated with potential variation have been demanded from the viewpoints of response to high-speed printing, full coloration, and suppression of color variation, recently further demanded.

### SUMMARY OF THE INVENTION

The present invention is directed to providing an electrophotographic photosensitive member that is capable of suppressing potential variation as much as possible to allow a high-quality image to be output.

Further, the present invention is directed to providing an electrophotographic apparatus and a process cartridge including the electrophotographic photosensitive member.

According to one aspect of the present invention, there is provided an electrophotographic photosensitive member comprising: a support; a charge-generating layer on the support; and a charge-transporting layer on the charge-generating layer, wherein the charge-generating layer comprises a gallium phthalocyanine crystal in which a polar solvent is contained, wherein the polar solvent is at least one selected from the group consisting of dimethylsulfoxide, N,N-dimethylformamide, N-methylformamide, N-propylformamide, N-vinylformamide and N-methylpyrrolidone, and wherein the content of the polar solvent is 0.1% by mass or more and 2.0% by mass or less based on a gallium phthalocyanine in the gallium phthalocyanine crystal, and the charge-transporting layer contains a compound represented by the following formula (1).

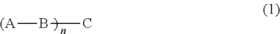

wherein A, B and C each independently represent any one of the following structures; and n represents 2 or 3.

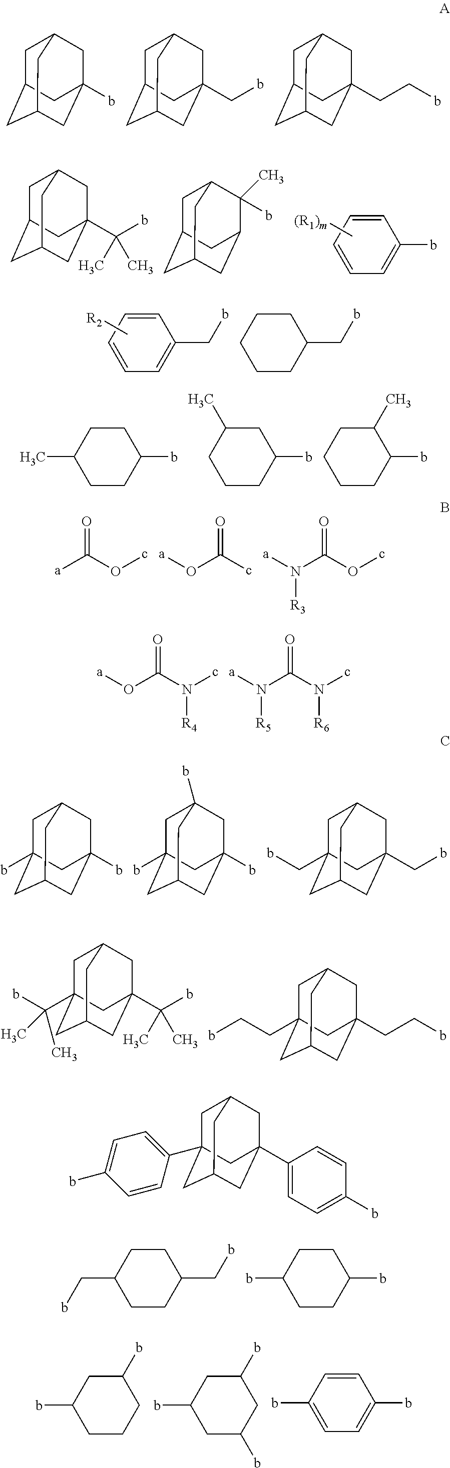

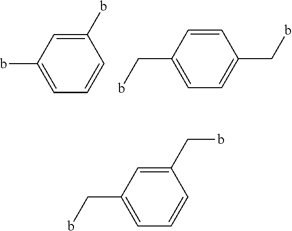

wherein site “a” represents a binding position to structure A; site “b” represents a binding position to structure B; site “c” represents a binding position to structure C; R₁ to R₆ each independently represent a hydrogen atom, a halogen atom, an alkoxy group or an alkyl group; and m represents 1 or 2.

According to another aspect of the present invention, there is provided a process cartridge detachably attachable to a main body of an electrophotographic apparatus, wherein the process cartridge integrally supports the electrophotographic photosensitive member, and at least one unit selected from the group consisting of a charging unit that charges a surface of the electrophotographic photosensitive member, a developing unit that develops an electrostatic latent image formed on the surface of the electrophotographic photosensitive member by a toner to form a toner image, and a cleaning unit that removes the toner on the surface of the electrophotographic photosensitive member after the toner image is transferred on a transfer material.

According to further aspect of the present invention, there is provided an electrophotographic apparatus including the electrophotographic photosensitive member, and including a charging unit that charges a surface of the electrophotographic photosensitive member, an image exposing unit that irradiates the surface charged of the electrophotographic photosensitive member with image exposing light to form an electrostatic latent image, a developing unit that develops the electrostatic latent image formed on the surface of the electrophotographic photosensitive member by a toner to form a toner image, and a transfer unit that transfers, on a transfer material, the toner image formed on the surface of the electrophotographic photosensitive member.

The present invention can provide an electrophotographic photosensitive member that contributes to suppress potential variation to allow a high-quality image to be output, as well as a process cartridge and an electrophotographic apparatus including the electrophotographic photosensitive member.

Further features of the present invention will become apparent from the following description of exemplary embodiments with reference to the attached drawings.

### BRIEF DESCRIPTION OF THE DRAWINGS

FIG. 1 is a view illustrating one example of a schematic configuration of an electrophotographic apparatus provided with a process cartridge including the electrophotographic photosensitive member of the present invention.

FIG. 2 is a powder X-ray diffraction diagram of a hydroxygallium phthalocyanine crystal obtained in Preparation Example 1.

FIG. 3 is a powder X-ray diffraction diagram of a chlorogallium phthalocyanine crystal obtained in Preparation Example 12.

### DESCRIPTION OF THE EMBODIMENTS

Preferred embodiments of the present invention will now be described in detail in accordance with the accompanying drawings.

The electrophotographic photosensitive member of the present invention comprises a support; a charge-generating layer on the support; and a charge-transporting layer on the charge-generating layer. The charge-generating layer comprises a gallium phthalocyanine crystal in which a polar solvent is contained (hereinafter, referred to as the polar solvent-containing gallium phthalocyanine crystal). The polar solvent contained in the gallium phthalocyanine crystal is at least one selected from the group consisting of dimethylsulfoxide, N,N-dimethylformamide, N-methylformamide, N-propylformamide, N-vinylformamide and N-methylpyrrolidone. The content of the polar solvent is 0.1% by mass or more and 2.0% by mass or less based on a gallium phthalocyanine in the gallium phthalocyanine crystal. Herein, the content of the polar solvent, when two or more of the polar solvents are contained, corresponds to the content based on the total amount of the respective polar solvents.

The charge-transporting layer contains a compound represented by the following formula (1).

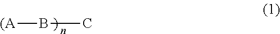

In formula (1), A, B and C are each independently represented by any one of the respective structural formulae shown below, and n represents 2 or 3. In the structural formulae, site “a” represents a binding position to structure A; site “b” represents a binding position to structure B; site “c” represents a binding position to structure C; R₁ to R₆ each independently represent a hydrogen atom, a halogen atom, an alkoxy group or an alkyl group; and m represents 1 or 2. R₁ to R₆ each independently represent a hydrogen atom, a halogen atom, an alkoxy group or an alkyl group.

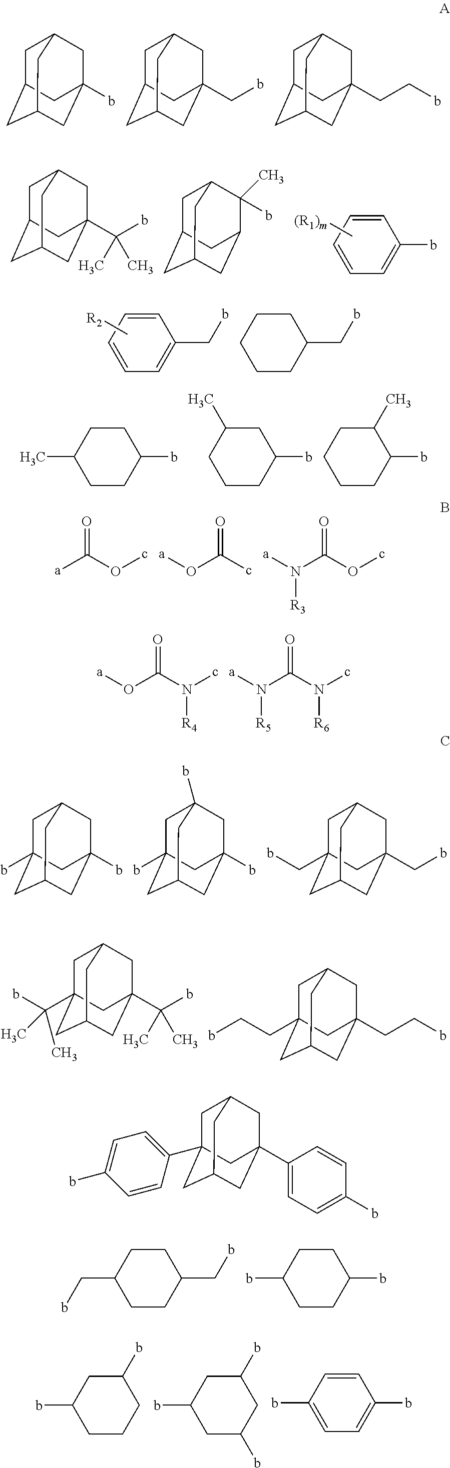

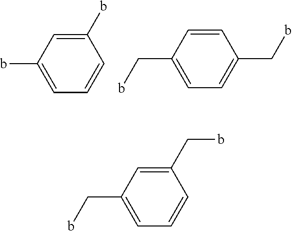

Herein, a plurality of (A-B)-'s in the formula (1) may have the same structure as each other.

The content of the polar solvent is preferably 0.1% by mass or more and 1.9% by mass or less, further more preferably 0.2% by mass or more and 1.9% by mass or less, particularly preferably 0.3% by mass or more and 1.5% by mass or less based on the gallium phthalocyanine in the gallium phthalocyanine crystal.

The polar solvent can be at least one selected from the group consisting of N-methylformamide, N-propylformamide, N-methylpyrrolidone and N-vinylformamide.

The halogen atom of each R₁ to R₆ in the formula (1) can include a fluorine atom, a chlorine atom, a bromine atom or an iodine atom. The alkoxy group can include an alkoxy group having 1 to 5 carbon atoms, preferably having 1 to 3 carbon atoms. The alkyl group can include an alkyl group having 1 to 5 carbon atoms, preferably having 1 to 3 carbon atoms.

R₁ to R₆ in the formula (1) can each independently represent a hydrogen atom or a methyl group.

B in the formula (1) can represent any one of the following structures.

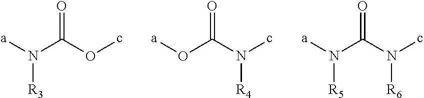

(In the above structures, R₃ to R₆ each independently represent a hydrogen atom or an alkyl group; and site “a” represents a binding position to structure A; and site “c” represents a binding position to structure C, respectively, in the formula (1).)

C in the formula (1) can also represent any one of the following structures.

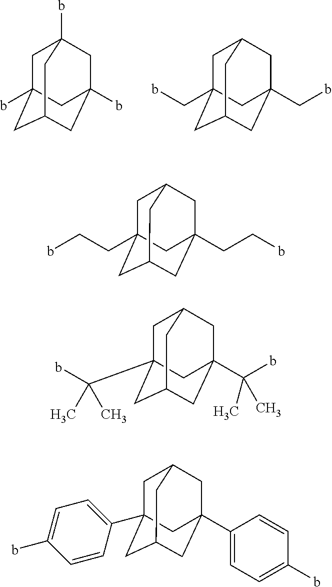

In the above structures, site “b” represents a binding position to structure B in the formula (1).

The compound of the formula (1) can be used singly or in combinations of two or more.

Hereinafter, specific examples (exemplary compounds) of the compound represented by the formula (1) contained in the electrophotographic photosensitive member of the present invention can be shown, but the present invention is not intended to be limited thereto.

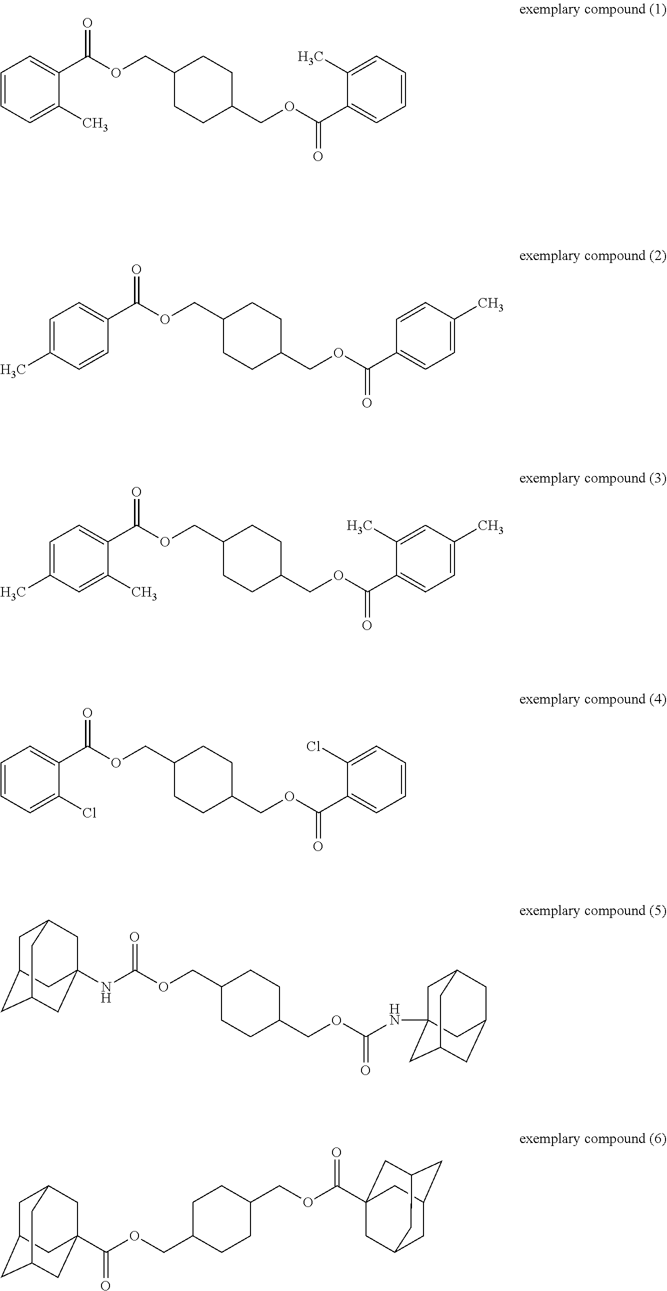

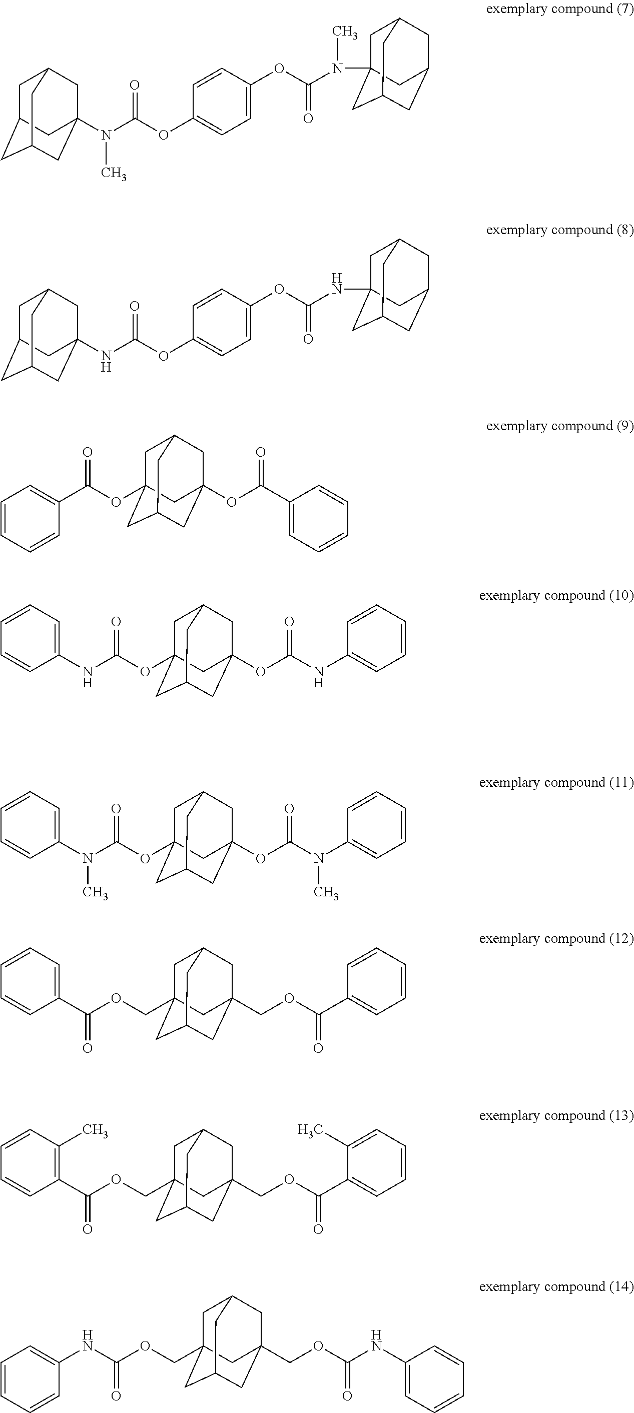

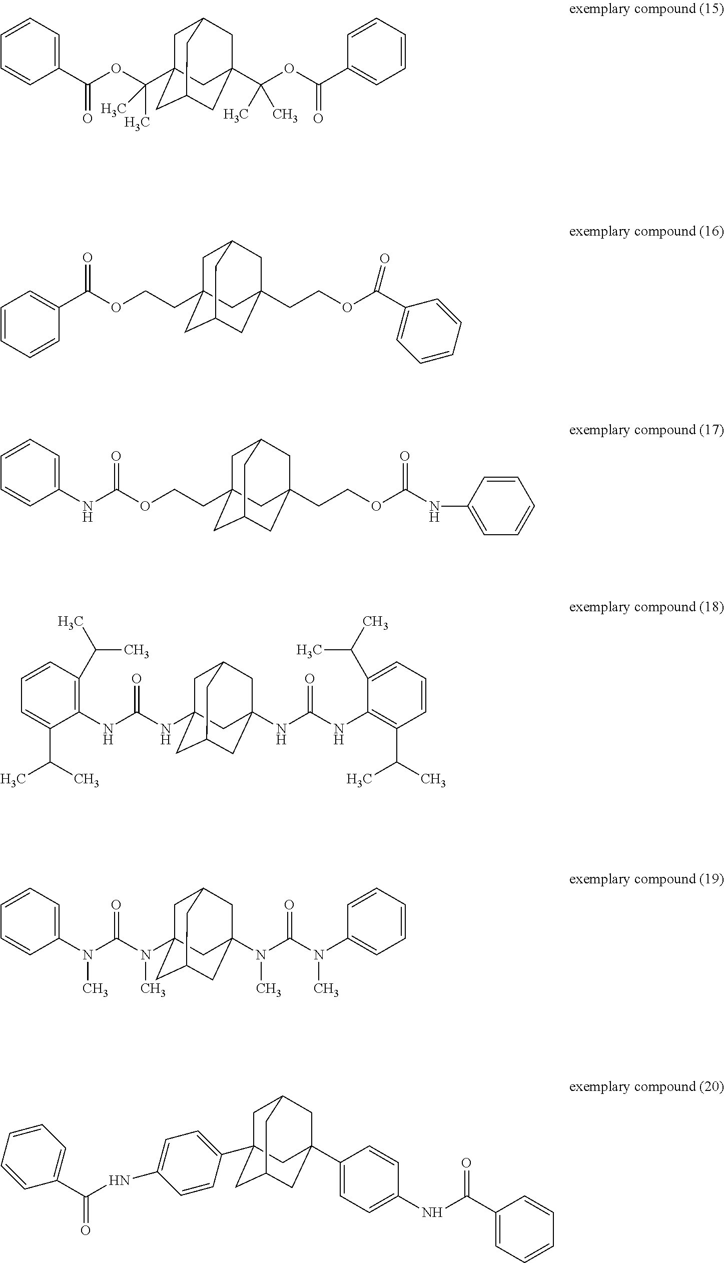 [SMILES: CC(C)(OC(=O)c1ccccc1)C12CC3CC(C1)CC(C(C)(C)OC(=O)c1ccccc1)(C3)C2 ; O=C(OCCC12CC3CC(C1)CC(CCOC(=O)c1ccccc1)(C3)C2)c1ccccc1 ; O=C(Nc1ccccc1)OCCC12CC3CC(C1)CC(CCOC(=O)Nc1ccccc1)(C3)C2 ; CC(C)c1cccc(C(C)C)c1NC(=O)NC12CC3CC(C1)CC(NC(=O)Nc1c(C(C)C)cccc1C(C)C)(C3)C2 ; CN(C(=O)N(C)C12CC3CC(C1)CC(N(C)C(=O)N(C)c1ccccc1)(C3)C2)c1ccccc1 ; O=C(Nc1ccc(C23CC4CC(C2)CC(c2ccc(NC(=O)c5ccccc5)cc2)(C4)C3)cc1)c1ccccc1]

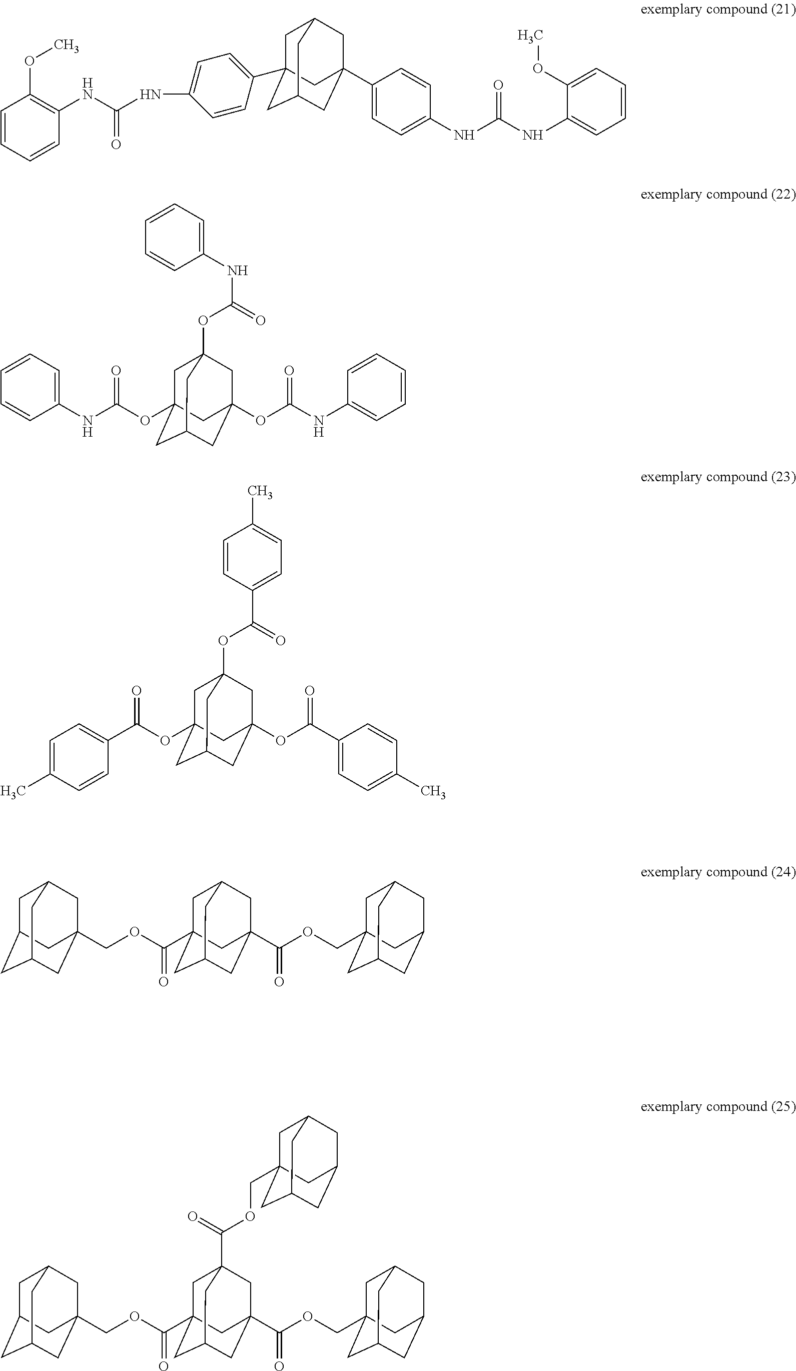

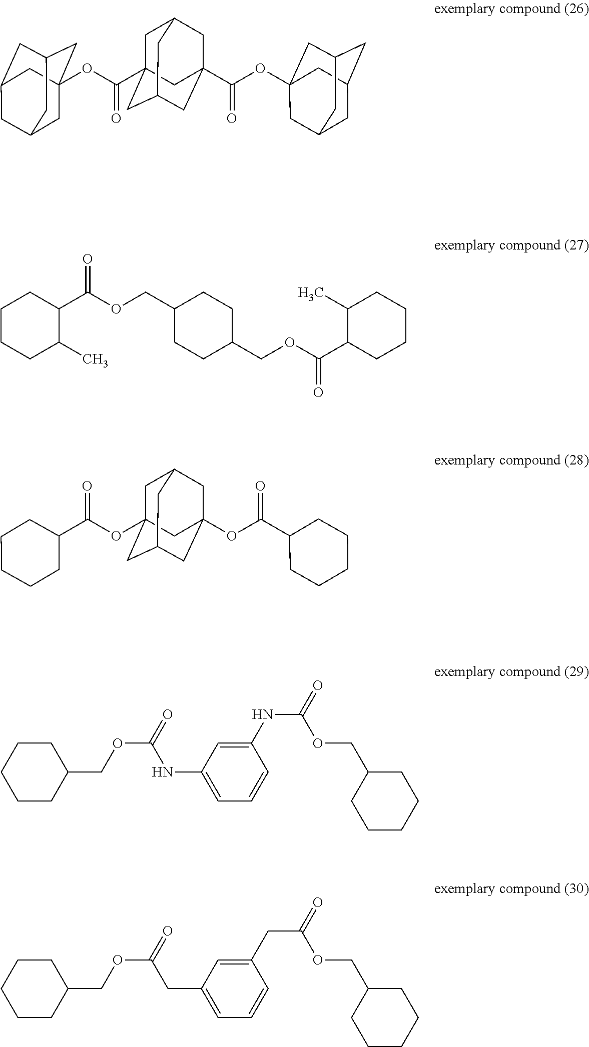 [SMILES: O=C(OC12CC3CC(CC(C3)C1)C2)C12CC3CC(C1)CC(C(=O)OC14CC5CC(CC(C5)C1)C4)(C3)C2 ; CC1CCCCC1C(=O)OCC1CCC(COC(=O)C2CCCCC2C)CC1 ; O=C(OC12CC3CC(C1)CC(OC(=O)C1CCCCC1)(C3)C2)C1CCCCC1 ; O=C(Nc1cccc(NC(=O)OCC2CCCCC2)c1)OCC1CCCCC1 ; O=C(Cc1cccc(CC(=O)OCC2CCCCC2)c1)OCC1CCCCC1]

The gallium phthalocyanine crystal is a crystal of a phthalocyanine compound having gallium as a central metal. As the gallium phthalocyanine crystal, a hydroxygallium phthalocyanine crystal, a chlorogallium phthalocyanine crystal, a bromogallium phthalocyanine crystal and an iodogallium phthalocyanine crystal having an excellent sensitivity act effectively in the present invention. The hydroxygallium phthalocyanine crystal has a hydroxy group as an axial ligand to a gallium atom. The chlorogallium phthalocyanine crystal has a chlorine atom as an axial ligand to a gallium atom. The bromogallium phthalocyanine crystal has a bromine atom as an axial ligand to a gallium atom. The iodogallium phthalocyanine crystal has an iodine atom as an axial ligand to a gallium atom. In particular, the hydroxygallium phthalocyanine crystal or the chlorogallium phthalocyanine crystal can be adopted.

Furthermore, the hydroxygallium phthalocyanine crystal is more preferably a hydroxygallium phthalocyanine crystal having peaks at Bragg angles 2θ of 7.4°±0.3° and 28.3°±0.3° in X-ray diffraction with CuKα rays, in terms of high sensitivity. Moreover, the chlorogallium phthalocyanine crystal is more preferably a chlorogallium phthalocyanine crystal having peaks at Bragg angles 2θ of 7.4°±0.2°, 16.6°±0.2°, 25.5°±0.2° and 28.3°±0.2° in X-ray diffraction with CuKα rays, in terms of high sensitivity.

The method for producing the polar solvent-containing gallium phthalocyanine crystal is described.

The polar solvent-containing gallium phthalocyanine crystal can be obtained in a step of subjecting a low-crystalline gallium phthalocyanine raw material to a wet milling treatment with a polar solvent-containing solvent for crystal transformation. As the low-crystalline gallium phthalocyanine raw material, one obtained by an acid pasting method or a dry milling treatment can be used.

The milling treatment conducted here is, for example, a treatment conducted using a milling apparatus such as a sand mill or a ball mill together with a dispersant as a medium for milling, such as glass beads, steel beads or an alumina ball. The milling time can be about 30 to 3000 hours. In particular, a method can be adopted in which a sample is taken every 10 to 100 hours and the content of the polar solvent in the gallium phthalocyanine crystal is confirmed by NMR measurement. The amount of the dispersant for use in the milling treatment can be 10 to 50 times the amount of the gallium phthalocyanine on a mass basis.

The amount of the polar solvent to be used can be 5 to 30 times the amount of the gallium phthalocyanine on a mass basis.

Whether the polar solvent-containing gallium phthalocyanine crystal contains the polar solvent in the crystal or not is determined in the present invention by subjecting the resulting gallium phthalocyanine crystal to NMR measurement.

X-ray diffraction and NMR measurements of the polar solvent-containing gallium phthalocyanine crystal included in the electrophotographic photosensitive member of the present invention are performed under the following conditions.

(Powder X-Ray Diffraction Measurement)

Measurement machine used: X-ray diffraction apparatus RINT-TTRII manufactured by Rigaku Corporation
X-ray tube bulb: Cu
Tube voltage: 50 KV
Tube current: 300 mA
Scanning method: 2θ/θ scanning
Scanning speed: 4.0°/minute
Sampling interval: 0.02°
Start angle (2θ): 5.0°
Stop angle (2θ): 40.0°
Attachment: standard specimen holder
Filter: not used
Incident monochromator: used
Counter monochromator: not used
Divergence slit: open
Vertical divergence limitation slit: 10.00 mm
Scattering slit: open
Light-receiving slit: open
Flat plate monochromator: used
Counter: scintillation counter

(NMR Measurement)

Measurement instrument used: AVANCEIII 500 manufactured by Bruker Corporation
Solvent: deuterosulfuric acid (D₂SO₄)

The electrophotographic photosensitive member of the present invention contains the gallium phthalocyanine crystal containing a specific amount of the polar solvent in the charge-generating layer, and contains the compound represented by the formula (1) in the charge-transporting layer. The present inventors consider that a polar resin contained in the gallium phthalocyanine crystal is set to be in a specific amount to thereby enhance flow of a photocarrier in the charge-generating layer, suppressing retention of the photocarrier, as a result, retention of the photocarrier can be suppressed to thereby enhance the effect of suppressing potential variation, and furthermore, the charge-transporting layer, which is allowed to contain the compound represented by the formula (1), can be combined with the charge-generating layer to thereby still more enhance the effect of suppressing potential variation.

The electrophotographic photosensitive member of the present invention includes the charge-generating layer provided on the support and the charge-transporting layer provided on the charge-generating layer.

The support for use in the present invention can be one having electro-conductivity (electro-conductive support). Examples include metals and alloys such as aluminum and stainless steel, or metals, alloys, plastics and paper provided with the electro-conductive layer. The shape of the support includes a cylindrical shape or a film shape.

In the present invention, an intermediate layer (also referred to as “undercoat layer”.) having a barrier function and an adhesion function can also be provided between the support and the charge-generating layer.

For the material of the intermediate layer, polyvinyl alcohol, polyethylene oxide, ethyl cellulose, methyl cellulose, casein, polyamide, glue, gelatin and the like are used. Such a material is dissolved in a proper solvent and applied onto the support. A metal oxide may also be added as a resistance control agent.

The thickness of the intermediate layer can be 0.3 to 5.0 μm.

Furthermore, an electro-conductive layer for the purposes of covering of irregularities and defects of the support and prevention of interference fringes can be provided between the support and the intermediate layer.

The electro-conductive layer can be formed by dispersing an electro-conductive particle such as carbon black, a metal particle and a metal oxide in a binder resin.

The thickness of the electro-conductive layer is preferably 5 to 40 μm, particularly preferably 10 to 30 μm.

The charge-generating layer is a layer including a charge-generating substance and can be formed by using at least a charge-generating substance (charge-generating material) and a binder resin. For example, the charge-generating layer can be formed by dip-coating the support with a coating liquid for a charge-generating layer to form a coating film and drying the coating film. The coating liquid for a charge-generating layer can be prepared by, for example, dispersing the charge-generating substance and the polar solvent-containing gallium phthalocyanine crystal as well as the binder resin in a solvent.

The thickness of the charge-generating layer is preferably 0.05 to 1 μm, more preferably 0.1 to 0.3 μm.

The content of the polar solvent-containing gallium phthalocyanine crystal in the charge-generating layer is preferably 40% by mass or more and 85% by mass or less, more preferably 60% by mass or more and 80% by mass or less based on the total mass of the charge-generating layer.

Examples of the binder resin for use in the charge-generating layer include resins such as polyester, an acrylic resin, polycarbonate, polyvinyl butyral, polystyrene, polyvinyl acetate, polysulfone, an acrylonitrile copolymer and polyvinyl benzal. In particular, polyvinyl butyral and polyvinyl benzal can be adopted for the resin that allows the polar solvent-containing gallium phthalocyanine crystal to be dispersed. Such resins can be used singly or in combinations of two or more.

The charge-transporting layer is a layer having a charge-transporting function, and further contains the compound represented by the formula (1). The charge-transporting layer can be formed by, for example, dip-coating the support with a coating liquid for a charge-transporting layer, in which the compound represented by the formula (1), a charge-transporting substance (charge-transporting material) and a binder resin are dissolved in a solvent, to form a coating film, and drying the coating film. In addition, at least one additive selected from a release agent for the purpose of an increase in transfer efficiency of a toner, a fingerprint adhesion inhibitor for the purpose of prevention of contamination and the like, a filler for the purpose of prevention of abrading and a lubricant for the purpose of an increase in lubricating property on the surface of the electrophotographic photosensitive member may also added to the charge-transporting layer.

The thickness of the charge-transporting layer is preferably 5 to 40 μm, particularly preferably 10 to 25 μm.

The content of the compound represented by the formula (1) in the charge-transporting layer is preferably 0.1% by mass or more and 20% by mass or less, more preferably 1% by mass or more and 10% by mass or less based on the total mass of the charge-transporting layer.

The content of the charge-transporting substance is preferably 20 to 80% by mass, particularly preferably 30 to 60% by mass based on the total mass of the charge-transporting layer.

The charge-transporting substance includes various triarylamine compounds, hydrazone compounds, stilbene compounds, pyrazoline compounds, oxazole compounds, thiazole compounds and triallylmethane compounds. In particular, a triarylamine compound can be adopted as the charge-transporting substance. The charge-transporting substance can be used singly or in combinations of two or more.

Examples of the binder resin for use in the charge-transporting layer include resins such as polyester, an acrylic resin, a phenoxy resin, polycarbonate, polysulfone, polyarylate and an acrylonitrile copolymer. In particular, polycarbonate and polyarylate can be adopted. Such resins can be used singly or in combinations of two or more.

For the coating method of each of the layers, a coating method selected from a dip-coating method (dipping method), a spray coating method, a spinner coating method, a bead coating method, a blade coating method and a beam coating method can be used.

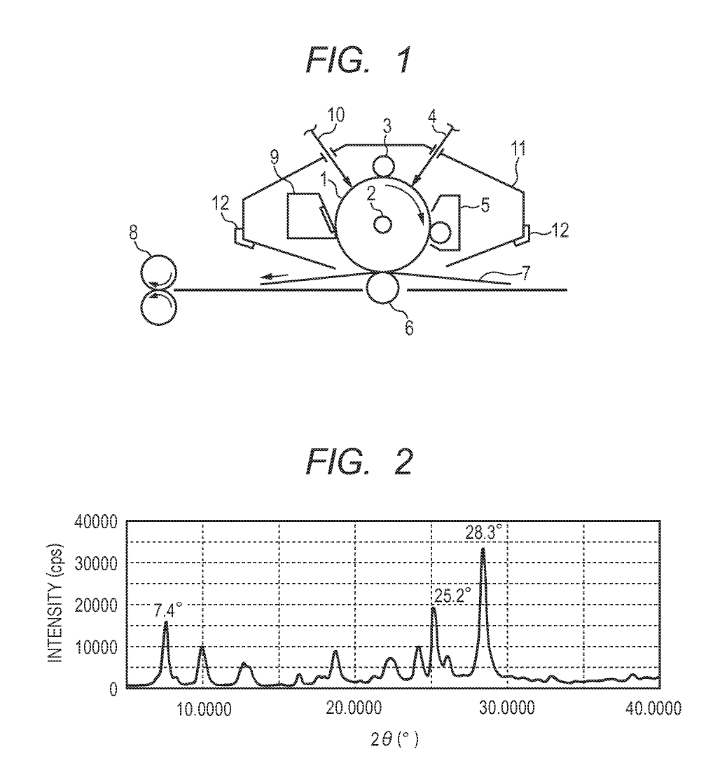

FIG. 1 is a view illustrating one example of a schematic configuration of an electrophotographic apparatus provided with a process cartridge including the electrophotographic photosensitive member of the present invention. The electrophotographic apparatus includes a cylindrical (drum-shaped) electrophotographic photosensitive member 1. The electrophotographic photosensitive member 1 is rotatably driven at a predetermined peripheral speed (process speed) about a shaft 2 in the arrow direction. The surface of the electrophotographic photosensitive member 1 is charged to a predetermined positive or negative potential by a charging unit 3 in the course of rotation. Next, the surface charged of the electrophotographic photosensitive member 1 is irradiated with image exposing light 4 from an image exposing unit (not illustrated), and an electrostatic latent image is formed according to image information intended. The image exposing light 4 is light intensity-modulated according to a time-series electric digital image signal of image information intended, the light being output from an image exposing unit such as a slit exposing unit or a laser beam scanning exposure unit.

The electrostatic latent image formed on the surface of the electrophotographic photosensitive member 1 is developed (regularly developed or reversely developed) by a toner accommodated in a developing unit 5, and a toner mage is formed on the surface of the electrophotographic photosensitive member 1. The toner image formed on the surface of the electrophotographic photosensitive member 1 is transferred on a transfer material 7 by a transfer unit 6. A bias voltage having a reverse polarity to the charge retained by the toner is here applied to the transfer unit from a bias power source (not illustrated). When the transfer material 7 is paper, the transfer material 7 is taken out from a paper-feeding unit (not illustrated) and fed between the electrophotographic photosensitive member 1 and the transfer unit 6 in synchronization with the rotation of the electrophotographic photosensitive member 1.

The transfer material 7, on which the toner image is transferred from the electrophotographic photosensitive member 1, is separated from the surface of the electrophotographic photosensitive member 1, conveyed to an image-fixing unit 8, subjected to a fixing treatment of the toner image and discharged as an image forming product (print, copy) outside the electrophotographic apparatus.

The surface of the electrophotographic photosensitive member 1, from which the toner image is transferred to the transfer material 7, is cleaned by removal of an adhering substance such as a toner (transfer residual toner) by a cleaning unit 9. A cleaner-less system has also been recently developed, and the transfer residual toner can also be directly removed by a developing machine or the like. Furthermore, the surface of the electrophotographic photosensitive member 1 is subjected to an antistatic treatment by pre-exposing light 10 from a pre-exposing unit (not illustrated), and thereafter repeatedly used for image formation. Herein, when the charging unit 3 is a contact charging unit using a charging roller or the like, the pre-exposing unit is not necessarily needed.

In the present invention, a plurality of constituent elements among the constituent elements such as the electrophotographic photosensitive member 1, the charging unit 3, the developing unit 5 and the cleaning unit 9 are accommodated in one container to be integrally supported to form a process cartridge. The process cartridge can be then configured to be detachably attachable to the main body of the electrophotographic apparatus. For example, at least one selected from the charging unit 3, the developing unit 5 and the cleaning unit 9 is integrally supported together with the electrophotographic photosensitive member 1 to form a cartridge, and the cartridge can be formed into a process cartridge 11 detachably attachable to the main body of the electrophotographic apparatus by using a guide unit 12 such as a rail of the main body of the electrophotographic apparatus.

When the electrophotographic apparatus is a copier or a printer, the image exposing light 4 may be light reflected or transmitted from an original manuscript. Alternatively, the image exposing light 4 may be light radiated by reading of the original manuscript by a sensor for conversion to signals, and scanning of a laser beam, driving of an LED array, driving of a liquid crystal shutter array, or the like performed according to the signals.

The electrophotographic photosensitive member 1 of the present invention can also be widely applied in the electrophotographic application field such as a laser beam printer, a CRT printer, an LED printer, FAX, a liquid crystal printer and laser plate making.

### EXAMPLES

Hereinafter, the present invention is described with reference to specific Examples in more detail. The present invention, however, is not limited thereto. “Part(s)” described below means “part(s) by mass”. Herein, the thickness of each of the layers of the electrophotographic photosensitive member in each of Examples and Comparative Examples was determined by an eddy current type film thickness meter (Fischerscope manufactured by Fischer Instruments), or determined from the mass per unit area in terms of specific gravity.

### Synthesis Example 1

Under a nitrogen flow atmosphere, 5.46 parts of phthalonitrile and 45 parts of α-chloronaphthalene were loaded to a reaction vessel and thereafter heated to a temperature of 30° C., and thereafter the temperature was kept. Next, 3.75 parts of gallium trichloride was loaded thereto at the temperature (30° C.). The moisture value of the mixed liquid in loading was 150 ppm. Thereafter, the temperature was raised to 200° C. Next, under a nitrogen flow atmosphere, the resultant was subjected to a reaction at a temperature of 200° C. for 4.5 hours and thereafter cooled, and when the temperature reached 150° C., the resultant was filtered to provide a product. The resulting product by filtration was dispersed in and washed with N,N-dimethylformamide at a temperature of 140° C. for 2 hours, and thereafter the resultant was filtered. The resulting product by filtration was washed with methanol, and thereafter dried to provide 4.65 parts of a chlorogallium phthalocyanine pigment (yield: 71%).

### Synthesis Example 2

The chlorogallium phthalocyanine pigment obtained in Synthesis Example 1 (4.65 parts) was dissolved in 139.5 parts of concentrated sulfuric acid at a temperature of 10° C., the resulting solution was dropped in 620 parts of ice water under stirring, for reprecipitation, and filtered using a filter press. The resulting wet cake (product by filtration) was dispersed in and washed with 2% ammonia water, and thereafter filtered using a filter press. Next, the resulting wet cake (product by filtration) was dispersed in and washed with ion-exchange water, thereafter filtration using a filter press was repeated three times, and thereafter a hydroxygallium phthalocyanine pigment (hydrous hydroxygallium phthalocyanine pigment) having a solid content of 23% was obtained.

Next, 6.6 kg of the resulting hydroxygallium phthalocyanine pigment (hydrous hydroxygallium phthalocyanine pigment) was dried using a Hyper-Dry dryer (product name: HD-06R, frequency (oscillation frequency): 2455 MHz±15 MHz, manufactured by Biocon (Japan) Ltd.) as follows.

The resulting hydroxygallium phthalocyanine pigment was placed on a dedicated circular plastic tray as a mass taken out from the filter press (the thickness of the hydrous cake: 4 cm or less), and far infrared rays were set to OFF and the temperature of the inner wall of the dryer was set to 50° C. Then, when irradiation with a microwave was performed, a vacuum pump and a leak valve were adjusted to the degree of vacuum to 4.0 to 10.0 kPa.

First, in a first step, the hydroxygallium phthalocyanine pigment was irradiated with a microwave of 4.8 kW for 50 minutes, and the microwave was then turned off once and the leak valve was closed once to provide a high vacuum atmosphere of 2 kPa or less. The solid content of the hydroxygallium phthalocyanine pigment here was 88% by mass.

In a second step, the leak valve was adjusted to the degree of vacuum (the pressure in the dryer) to the setting value (4.0 to 10.0 kPa), thereafter the hydroxygallium phthalocyanine pigment was irradiated with a microwave of 1.2 kW for 5 minutes, and the microwave was turned off once and the leak valve was closed once to provide a high vacuum of 2 kPa or less. The second step was repeated one more time (twice in total). The solid content of the hydroxygallium phthalocyanine pigment here was 98% by mass.

Furthermore, in a third step, irradiation with a microwave was performed in the same manner as in the second step except that the microwave in the second step was changed from 1.2 kW to 0.8 kW. The third step was repeated one more time (twice in total).

Furthermore, in a fourth step, the leak valve was adjusted to the degree of vacuum (the pressure in the dryer) to the setting value (4.0 to 10.0 kPa), thereafter the hydroxygallium phthalocyanine pigment was irradiated with a microwave of 0.4 kW for 3 minutes, and the microwave was turned off once and the leak valve was closed once to provide a high vacuum of 2 kPa or less. The fourth step was further repeated seven times (8 times in total).

As described above, 1.52 kg of a hydroxygallium phthalocyanine pigment having a water content of 1% by mass or less was obtained in 3 hours in total.

### Preparation Example 1

The hydroxygallium phthalocyanine pigment obtained in Synthesis Example 2 (0.5 parts) and 10 parts of N,N-dimethylformamide were subjected to a milling treatment by a ball mill together with 20 parts of glass beads having a diameter of 0.8 mm under conditions of room temperature (23° C.) and 120 rpm for 400 hours. A gallium phthalocyanine crystal was taken out from the thus obtained dispersion by using N,N-dimethylformamide, and filtration was conducted and a filter was sufficiently washed with tetrahydrofuran. A product taken out by filtration was dried under vacuum to provide 0.45 parts of a polar solvent-containing hydroxygallium phthalocyanine crystal. The powder X-ray diffraction diagram of the resulting crystal is illustrated in FIG. 2.

It was confirmed by NMR measurement that the content of N,N-dimethylformamide in the hydroxygallium phthalocyanine crystal obtained in Preparation Example 1 was 1.4% by mass in terms of the ratio of proton. N,N-dimethylformamide was compatible with tetrahydrofuran, and therefore it was found that N,N-dimethylformamide was contained in the crystal.

### Preparation Example 2

Except that the milling treatment time was changed from 400 hours to 2000 hours in Preparation Example 1, the same manner as in Preparation Example 1 was performed to provide 0.43 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N,N-dimethylformamide in the hydroxygallium phthalocyanine crystal obtained in Preparation Example 2 was 0.8% by mass in terms of the ratio of proton.

### Preparation Example 3

Except that 10 parts of N,N-dimethylformamide was changed to 10 parts of dimethylsulfoxide and the milling treatment time was changed from 400 hours to 100 hours in Preparation Example 1, the same manner as in Preparation Example 1 was performed to provide 0.40 parts of a polar solvent-containing hydroxygallium phthalocyanine crystal. The powder X-ray diffraction of the polar solvent-containing hydroxygallium phthalocyanine crystal thus obtained was similar as the powder X-ray diffraction illustrated in FIG. 2.

It was confirmed by NMR measurement that the content of dimethylsulfoxide in the hydroxygallium phthalocyanine crystal obtained in Preparation Example 3 was 2.0% by mass in terms of the ratio of proton.

### Preparation Example 4

Except that the milling treatment time was changed from 100 hours to 2000 hours in Preparation Example 3, the same manner as in Preparation Example 3 was performed to provide 0.39 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of dimethylsulfoxide in the hydroxygallium phthalocyanine crystal obtained in Preparation Example 4 was 0.7% by mass in terms of the ratio of proton.

### Preparation Example 5

Except that 10 parts of N,N-dimethylformamide was changed to 10 parts of N-methylformamide and the milling treatment time was changed from 400 hours to 200 hours in Preparation Example 1, the same manner was performed as in Preparation Example 1 to provide 0.45 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-methylformamide in the hydroxygallium phthalocyanine crystal obtained in Preparation Example 5 was 1.2% by mass in terms of the ratio of proton.

### Preparation Example 6

Except that the milling treatment time was changed from 200 hours to 1000 hours in Preparation Example 5, the same manner as in Preparation Example 5 was performed to provide 0.43 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-methylformamide in the hydroxygallium phthalocyanine crystal obtained in Preparation Example 6 was 0.5% by mass in terms of the ratio of proton.

### Preparation Example 7

Except that 10 parts of N,N-dimethylformamide was changed to 10 parts of N-n-propylformamide and the milling treatment time was changed from 400 hours to 300 hours in Preparation Example 1, the same manner as in Preparation Example 1 was performed to provide 0.45 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-n-propylformamide in the hydroxygallium phthalocyanine crystal obtained in Preparation Example 7 was 1.6% by mass in terms of the ratio of proton.

### Preparation Example 8

Except that the milling treatment time was changed from 300 hours to 1000 hours in Preparation Example 7, the same manner as in Preparation Example 7 was performed to provide 0.43 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-n-propylformamide in the hydroxygallium phthalocyanine crystal obtained in Preparation Example 8 was 0.9% by mass in terms of the ratio of proton.

### Preparation Example 9

Except that 10 parts of N,N-dimethylformamide was changed to 10 parts of N-vinylformamide and the milling treatment time was changed from 400 hours to 200 hours in Preparation Example 1, the same manner as in Preparation Example 1 was performed to provide 0.45 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-vinylformamide in the hydroxygallium phthalocyanine crystal obtained in Preparation Example 9 was 1.8% by mass in terms of the ratio of proton.

### Preparation Example 10

Except that the milling treatment time was changed from 200 hours to 600 hours in Preparation Example 9, the same manner as in Preparation Example 9 was performed to provide 0.45 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-vinylformamide in the hydroxygallium phthalocyanine crystal obtained in Preparation Example 10 was 1.5% by mass in terms of the ratio of proton.

### Preparation Example 11

Except that 10 parts of N,N-dimethylformamide was changed to 10 parts of N-methyl-2-pyrrolidone and the milling treatment time was changed from 400 hours to 800 hours in Preparation Example 1, the same manner as in Preparation Example 1 was performed to provide 0.44 parts of a polar solvent-containing hydroxygallium phthalocyanine crystal. The powder X-ray diffraction of the resulting polar solvent-containing hydroxygallium phthalocyanine crystal was similar as the powder X-ray diffraction illustrated in FIG. 2.

It was confirmed by NMR measurement that the content of N-methyl-2-pyrrolidone in the hydroxygallium phthalocyanine crystal obtained in Preparation Example 11 was 1.4% by mass in terms of the ratio of proton.

### Preparation Example 12

The chlorogallium phthalocyanine obtained in Synthesis Example 1 (0.5 parts) was subjected to a dry milling treatment by a ball mill together with 20 parts of glass beads having a diameter of 0.8 mm at room temperature (23° C.) for 40 hours. Ten parts of N,N-dimethylformamide was added thereto and subjected to a wet milling treatment at room temperature (23° C.) for 100 hours.

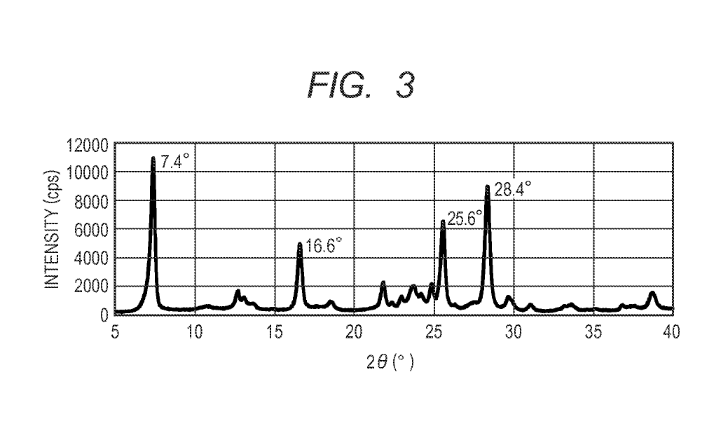

A gallium phthalocyanine crystal was taken out from the resulting dispersion by using N,N-dimethylformamide, and filtration was conducted and a filter was sufficiently washed with tetrahydrofuran. A product taken out by filtration, washed here, was dried under vacuum to provide 0.44 parts of a polar solvent-containing chlorogallium phthalocyanine crystal. The powder X-ray diffraction diagram of the resulting crystal is illustrated in FIG. 3.

It was confirmed by NMR measurement that the content of N,N-dimethylformamide in the chlorogallium phthalocyanine crystal obtained in Preparation Example 12 was 1.0% by mass in terms of the ratio of proton.

### Preparation Example 13

Except that 10 parts of N,N-dimethylformamide was changed to 10 parts of N-methylformamide in Preparation Example 12, the same manner as in Preparation Example 12 was performed to provide 0.45 parts of a chlorogallium phthalocyanine crystal. The powder X-ray diffraction of the resulting chlorogallium phthalocyanine crystal was similar as the powder X-ray diffraction illustrated in FIG. 3.

It was confirmed by NMR measurement that the content of N-methylformamide in the chlorogallium phthalocyanine crystal obtained in Preparation Example 13 was 1.5% by mass in terms of the ratio of proton.

### Preparation Example 14

Except that 10 parts of N,N-dimethylformamide was changed to 10 parts of dimethylsulfoxide and the milling treatment time was changed from 400 hours to 140 hours in Preparation Example 1, the same manner as in Preparation Example 1 was performed to provide 0.41 parts of a polar solvent-containing hydroxygallium phthalocyanine crystal. The powder X-ray diffraction of the polar solvent-containing hydroxygallium phthalocyanine crystal thus obtained was similar as the powder X-ray diffraction illustrated in FIG. 2.

It was confirmed by NMR measurement that the content of dimethylsulfoxide in the hydroxygallium phthalocyanine crystal obtained in Preparation Example 14 was 1.9% by mass in terms of the ratio of proton.

### Comparative Preparation Example 1

Except that the milling treatment time was changed from 400 hours to 48 hours in Preparation Example 1, the same manner as in Preparation Example 1 was performed to provide 0.46 parts of a polar solvent-containing hydroxygallium phthalocyanine crystal.

It was confirmed by NMR measurement that the content of N,N-dimethylformamide in the hydroxygallium phthalocyanine crystal obtained in Comparative Preparation Example 1 was 2.1% by mass in terms of the ratio of proton.

### Comparative Preparation Example 2

Except that the milling treatment time was changed from 100 hours to 48 hours in Preparation Example 3, the same manner as in Preparation Example 3 was performed to provide 0.41 parts of a polar solvent-containing hydroxygallium phthalocyanine crystal.

It was confirmed by NMR measurement that the content of dimethylsulfoxide in the hydroxygallium phthalocyanine crystal obtained in Comparative Preparation Example 2 was 2.1% by mass in terms of the ratio of proton.

### Comparative Preparation Example 3

Except that the milling treatment time was changed from 800 hours to 48 hours in Preparation Example 11, the same manner as in Preparation Example 11 was performed to provide 0.44 parts of a polar solvent-containing hydroxygallium phthalocyanine crystal.

It was confirmed by NMR measurement that the content of N-methyl-2-pyrrolidone in the hydroxygallium phthalocyanine crystal obtained in Comparative Preparation Example 3 was 3.0% by mass in terms of the ratio of proton.

### Example 1

A solution including the following respective components was subjected to a dispersing treatment by a ball mill for 20 hours to prepare a coating liquid for an electro-conductive layer.
60 parts of barium sulfate particle covered with tin oxide (product name: Pastolan PC1, produced by Mitsui Mining & Smelting Co., Ltd.)
15 parts of titanium oxide particle (product name: TITANIX JR, produced by Tayca)
43 parts of resol type phenol resin (product name: Phenolite J-325, produced by DIC Corporation, solid content: 70% by mass)
0.015 parts of silicone oil (product name: SH28PA, produced by Dow Corning Toray Silicone Co., Ltd.)
3.6 parts of silicone resin (product name: Tospearl 120, produced by Toshiba Silicone Co., Ltd.)
50 parts of 2-methoxy-1-propanol
50 parts of methanol

The outer periphery of an alumina cylinder as the support was dip-coated with the coating liquid for an electro-conductive layer to form a coating film, and the coating film was dried at 140° C. for 30 minutes to thereby form an electro-conductive layer having a thickness of 15 μm.

Next, 10 parts of a copolymerized nylon resin (product name: Amilan CM8000, produced by Toray Industries Inc.) and 30 parts of a methoxymethylated 6 nylon resin (product name: Tresin EF-30T, produced by Teikoku Chemical Industries Co., Ltd.) were dissolved in a mixed solvent of 400 parts of methanol/200 parts of n-butanol to thereby prepare a coating liquid for an undercoat layer.

The electro-conductive layer was dip-coated with the coating liquid for an undercoat layer to form a coating film, and the coating film was dried to thereby form an undercoat layer having a thickness of 0.7 μm.

Next, 10 parts of the polar solvent-containing hydroxygallium phthalocyanine crystal (charge-generating substance) obtained in Preparation Example 1, 5 parts of polyvinyl butyral (product name: S-LEC BX-1, produced by Sekisui Chemical Co., Ltd.) and 250 parts of cyclohexanone were loaded in a sand mill using glass beads having a diameter of 1 mm and subjected to a dispersing treatment for 6 hours, and 250 parts of ethyl acetate was added thereto for diluting to thereby prepare a coating liquid for a charge-generating layer.

The undercoat layer was dip-coated with the coating liquid for a charge-generating layer to form a coating film, and the coating film was dried at 100° C. for 10 minutes to thereby form a charge-generating layer having a thickness of 0.22 μm.

Next, the following respective components were dissolved in a mixed solvent of 70 parts of o-xylene and 20 parts of dimethoxyethane to thereby prepare a coating liquid for a charge-transporting layer.
6 parts of compound represented by the following formula (CTM-1) (charge-transporting substance)
3 parts of compound represented by the following formula (CTM-2) (charge-transporting substance)
1 part of exemplary compound (1)
0.03 parts of fingerprint adhesion inhibitor (product name: Optool DAC-HP, produced by Daikin Industries Ltd.)
0.07 parts of fluorine-based surface modifier (product name: FA-E-50, produced by Nissan Chemical Industries Ltd.)
0.1 parts of lubricant represented by the following formula (PcSi-1)
10 parts of polycarbonate (product name: Iupilon Z-200, produced by Mitsubishi Gas Chemical Company Inc.)

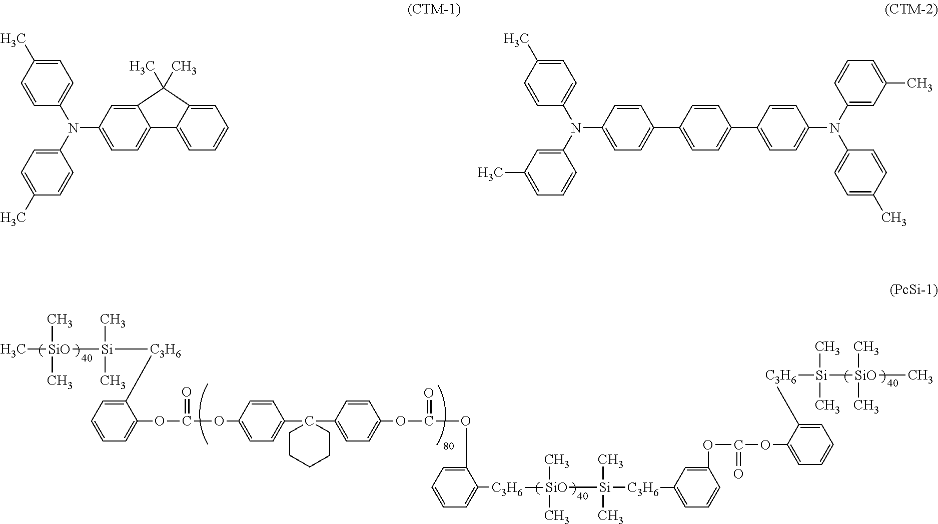

The charge-generating layer was dip-coated with the coating liquid for a charge-transporting layer to form a coating film, and the coating film was dried at 125° C. for 1 hour to thereby form a charge-transporting layer having a thickness of 15.5 μm.

Thus, a cylindrical (drum-shaped) electrophotographic photosensitive member in Example 1 was produced.

### Example 2

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 2 and exemplary compound (1) in preparation of the coating liquid for a charge-transporting layer was changed to exemplary compound (6), the same manner as in Example 1 was performed to produce an electrophotographic photosensitive member in Example 2.

### Example 3

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 3, and exemplary compound (1) in preparation of the coating liquid for a charge-transporting layer was changed to exemplary compound (9), the same manner as in Example 1 was performed to produce an electrophotographic photosensitive member in Example 3.

### Example 4

Except that, in Example 3, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 4, the same manner as in Example 3 was performed to produce an electrophotographic photosensitive member in Example 4.

### Example 5

Except that, in Example 1, the hydroxygallium phthalocyanine crystal obtained in Preparation Example 1 in preparation of the coating liquid for a charge-generating layer was changed to the hydroxygallium phthalocyanine crystal obtained in Preparation Example 5, the same manner as in Example 1 was performed to produce an electrophotographic photosensitive member in Example 5.

### Example 6

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 6 and exemplary compound (1) in preparation of the coating liquid for a charge-transporting layer was changed to exemplary compound (25), the same manner as in Example 1 was performed to produce an electrophotographic photosensitive member in Example 6.

### Example 7

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 7 and exemplary compound (1) in preparation of the coating liquid for a charge-transporting layer was changed to exemplary compound (13), the same manner as in Example 1 was performed to produce an electrophotographic photosensitive member in Example 7.

### Example 8

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 8 and exemplary compound (1) in preparation of the coating liquid for a charge-transporting layer was changed to exemplary compound (5), the same manner as in Example 1 was performed to produce an electrophotographic photosensitive member in Example 8.

### Example 9

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 9 and exemplary compound (1) in preparation of the coating liquid for a charge-transporting layer was changed to exemplary compound (26), the same manner as in Example 1 was performed to produce an electrophotographic photosensitive member in Example 9.

### Example 10

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 10 and 1 part of exemplary compound (1) in preparation of the coating liquid for a charge-transporting layer was changed to 0.3 parts of exemplary compound (22), the same manner as in Example 1 was performed to produce an electrophotographic photosensitive member in Example 10.

### Example 11

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Preparation Example 11, and exemplary compound (1) in preparation of the coating liquid for a charge-transporting layer was changed to exemplary compound (15), the same manner as in Example 1 was performed to produce an electrophotographic photosensitive member in Example 11.

### Example 12

Except that, in Example 1, the polar solvent-containing hydroxygallium phthalocyanine crystal obtained in Preparation Example 1 in preparation of the coating liquid for a charge-generating layer was changed to the polar solvent-containing chlorogallium phthalocyanine crystal obtained in Preparation Example 12 and 1 part of exemplary compound (1) in preparation of the coating liquid for a charge-transporting layer was changed to 0.3 parts of exemplary compound (18), the same manner as in Example 1 was performed to produce an electrophotographic photosensitive member in Example 12.

### Example 13

Except that, in Example 1, the polar solvent-containing hydroxygallium phthalocyanine crystal obtained in Preparation Example 1 in preparation of the coating liquid for a charge-generating layer was changed to the polar solvent-containing chlorogallium phthalocyanine crystal obtained in Preparation Example 13 and 1 part of exemplary compound (1) in preparation of the coating liquid for a charge-transporting layer was changed to 0.3 parts of exemplary compound (19), the same manner as in Example 1 was performed to produce an electrophotographic photosensitive member in Example 13.

### Example 14

Except that, in Example 3, the polar solvent-containing hydroxygallium phthalocyanine crystal obtained in Preparation Example 3 in preparation of the coating liquid for a charge-generating layer was changed to the polar solvent-containing hydroxygallium crystal obtained in Preparation Example 14, the same manner as in Example 3 was performed to produce an electrophotographic photosensitive member in Example 14.

### Comparative Example 1

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Comparative Preparation Example 1 and exemplary compound (1) in preparation of the coating liquid for a charge-transporting layer was not added, the same manner as in Example 1 was performed to produce an electrophotographic photosensitive member in Comparative Example 1.

### Comparative Example 2

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Comparative Preparation Example 2 and exemplary compound (1) in preparation of the coating liquid for a charge-transporting layer was not added, the same manner as in Example 1 was performed to produce an electrophotographic photosensitive member in Comparative Example 2.

### Comparative Example 3

Except that, in Example 1, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Comparative Preparation Example 3 and exemplary compound (1) in preparation of the coating liquid for a charge-transporting layer was not added, the same manner as in Example 1 was performed to produce an electrophotographic photosensitive member in Comparative Example 3.

### Comparative Example 4

Except that, in Example 3, exemplary compound (9) in preparation of the coating liquid for a charge-transporting layer was not added, the same manner as in Example 3 was performed to produce an electrophotographic photosensitive member in Comparative Example 4.

### Comparative Example 5

Except that, in Example 3, the polar solvent-containing hydroxygallium phthalocyanine crystal obtained in Preparation Example 1 in preparation of the coating liquid for a charge-generating layer was changed to the polar solvent-containing hydroxygallium phthalocyanine crystal obtained in Comparative Preparation Example 2, the same manner as in Example 3 was performed to produce an electrophotographic photosensitive member in Comparative Example 5.

### Comparative Example 6

Except that, in Example 12, exemplary compound (18) in preparation of the coating liquid for a charge-transporting layer was not added, the same manner as in Example 12 was performed to produce an electrophotographic photosensitive member in Comparative Example 6.

Except that, in each of Examples 2 to 14 and Comparative Examples 1 to 6, the materials associated with the polar solvent-containing phthalocyanine crystal and the compound of the formula (1) were changed, the same manner as in Example 1 was performed to produce an electrophotographic photosensitive member. Such changes of the materials are shown in Table 1 and Table 2.

TABLE 1

| | Axial ligand of polar | |
|---|---|---|
| | solvent-containing | |
| | gallium phthalocyanine | Ratio of compound |
| | crystal, and type and | of formula (1) to |
| | content of polar solvent | be compounded |
| Example 1 | Hydroxy, | Exemplary |
| | N,N-dimethylformamide: | compound (1): |
| | 1.4% by mass % | 1 part |
| | (Preparation Example 1) | |
| Example 2 | Hydroxy, | Exemplary |
| | N,N-dimethylformamide: | compound (6): |
| | 0.8% by mass % | 1 part |
| | (Preparation Example 2) | |
| Example 3 | Hydroxy, | Exemplary |
| | dimethylsulfoxide: | compound (9): |
| | 2.0% by mass % | 1 part |
| | (Preparation Example 3) | |
| Example 4 | Hydroxy, | Exemplary |
| | dimethylsulfoxide: | compound (9): |
| | 0.7% by mass % | 1 part |
| | (Preparation Example 4) | |
| Example 5 | Hydroxy, | Exemplary |
| | N-methylformamide: | compound (1): |
| | 1.2% by mass % | 1 part |
| | (Preparation Example 5) | |
| Example 6 | Hydroxy, | Exemplary |
| | N-methylformamide: | compound (25): |
| | 0.5% by mass % | 1 part |
| | (Preparation Example 6) | |
| Example 7 | Hydroxy, | Exemplary |
| | N-n-propylformamide: | compound (13): |
| | 1.6% by mass % | 1 part |
| | (Preparation Example 7) | |
| Example 8 | Hydroxy, | Exemplary |
| | N-n-propylformamide: | compound (5): |
| | 0.9% by mass % | 1 part |
| | (Preparation Example 8) | |
| Example 9 | Hydroxy, | Exemplary |
| | N-vinylformamide: | compound (26): |
| | 1.8% by mass % | 1 part |
| | (Preparation Example 9) | |
| Example 10 | Hydroxy, | Exemplary |
| | N-vinylformamide: | compound (22): |
| | 1.5% by mass % | 0.3 parts |
| | (Preparation Example 10) | |

TABLE 2

| | Axial ligand of polar | |
|---|---|---|
| | solvent-containing | |
| | gallium phthalocyanine | Ratio of compound |
| | crystal, and type and | of formula (1) to |
| | content of polar solvent | be compounded |
| Example 11 | Hydroxy, | Exemplary |
| | N-methyl-2-pyrrolidone: | compound (15): |
| | 1.4% by mass % | 1 part |
| | (Preparation Example 11) | |
| Example 12 | Chloro, | Exemplary |
| | N, N-dimethylformamide: | compound (18): |
| | 1.0% by mass % | 0.3 parts |
| | (Preparation Example 12) | |
| Example 13 | Chloro, | Exemplary |
| | N-methylformamide: | compound (19): |
| | 1.5% by mass % | 0.3 parts |
| | (Preparation Example 13) | |
| Example 14 | Hydroxy, | Exemplary |
| | dimethylsulfoxide: | compound (9): |
| | 1.9% by mass % | 1 part |
| | (Preparation Example 14) | |
| Comparative | Hydroxy, | Not added |
| Example 1 | N,N-dimethylformamide: | |
| | 2.1% by mass % | |
| | (Comparative Preparation | |
| | Example 1) | |
| Comparative | Hydroxy, | Not added |
| Example 2 | dimethylsulfoxide: | |
| | 2.1% by mass % | |
| | (Comparative Preparation | |
| | Example 2) | |
| Comparative | Hydroxy, | Not added |
| Example 3 | N-methyl-2-pyrrolidone: | |
| | 3.0% by mass % | |
| | (Comparative Preparation | |
| | Example 3) | |
| Comparative | Hydroxy, | Not added |
| Example 4 | dimethylsulfoxide: | |
| | 2.0% by mass % | |
| | (Preparation Example 3) | |
| Comparative | Hydroxy, | Exemplary |
| Example 5 | dimethylsulfoxide: | compound (9): |
| | 2.1% by mass % | 1 part |
| | (Comparative Preparation | |
| | Example 2) | |
| Comparative | Chloro, | Not added |
| Example 6 | N,N-dimethylformamide: | |
| | 1.0% by mass % | |
| | (Preparation Example 12) | |

### Evaluation of Examples 1 to 14 and Comparative Examples 1 to 6

The electrophotographic photosensitive member in each of Examples 1 to 14 and Comparative Examples 1 to 6 was evaluated with respect to the variation in bright portion potential (potential variation) in repeated use for 10,000 sheets.

A laser beam printer CP-4525 manufactured by Hewlett-Packard Development Company, L.P. was altered so as to enable to adjust the charging potential (dark portion potential) of the electrophotographic photosensitive member, and used as an evaluation apparatus. The evaluation was performed under an environment of a temperature of 23° C. and a relative humidity of 50%.

<Evaluation of Potential Variation>

The amount of exposure light at 780 nm of a laser light source of the evaluation apparatus (amount of image exposure) was set so that the amount of light on the surface of the electrophotographic photosensitive member was 0.37 μJ/cm². Measurement of the surface potential (dark portion potential and bright portion potential) of the electrophotographic photosensitive member was conducted at a developing unit position, while a tool secured so that a probe for potential measurement was located at a position of 130 mm from the end of the electrophotographic photosensitive member, was exchanged with a developing unit. The dark portion potential of a region not exposed of the electrophotographic photosensitive member was set to be −500 V, and the bright portion potential obtained by light attenuation from the dark portion potential with laser light irradiation was measured. In addition, an image was continuously output on A4 size plain paper for 10,000 sheets, and the amount of variation in the bright portion potential before and after such outputting was evaluated. As a test chart, one having a printing rate of 4% was used. The results are shown in the potential variation in Table 3.

TABLE 3

| | Potential |
|---|---|
| | variation (V) |
| Example 1 | 45 |
| Example 2 | 40 |
| Example 3 | 55 |
| Example 4 | 40 |
| Example 5 | 30 |
| Example 6 | 20 |
| Example 7 | 50 |
| Example 8 | 35 |
| Example 9 | 50 |
| Example 10 | 35 |
| Example 11 | 30 |
| Example 12 | 45 |
| Example 13 | 30 |
| Example 14 | 40 |
| Comparative | 120 |
| Example 1 | |
| Comparative | 140 |
| Example 2 | |
| Comparative | 150 |
| Example 3 | |
| Comparative | 100 |
| Example 4 | |
| Comparative | 120 |
| Example 5 | |
| Comparative | 100 |
| Example 6 | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-122841, filed Jun. 13, 2014, and Japanese Patent Application No. 2014-241841, filed Nov. 28, 2014, which are hereby incorporated by reference herein in their entirety.

What is claimed is:

1. An electrophotographic photosensitive member comprising:
a support;
a charge-generating layer on the support; and
a charge-transporting layer on the charge-generating layer, wherein
the charge-generating layer comprises a gallium phthalocyanine crystal in which a polar solvent is contained,
wherein the polar solvent is at least one selected from the group consisting of dimethylsulfoxide, N,N-dimethylformamide, N-methylformamide, N-propylformamide, N-vinylformamide and N-methylpyrrolidone, and
wherein the content of the polar solvent is 0.1% by mass or more and 2.0% by mass or less based on a gallium phthalocyanine in the gallium phthalocyanine crystal, and
the charge-transporting layer comprises a compound represented by the following formula (1): 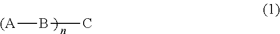
wherein A, B and C each independently represent any one of the following structures; and n represents 2 or 3; 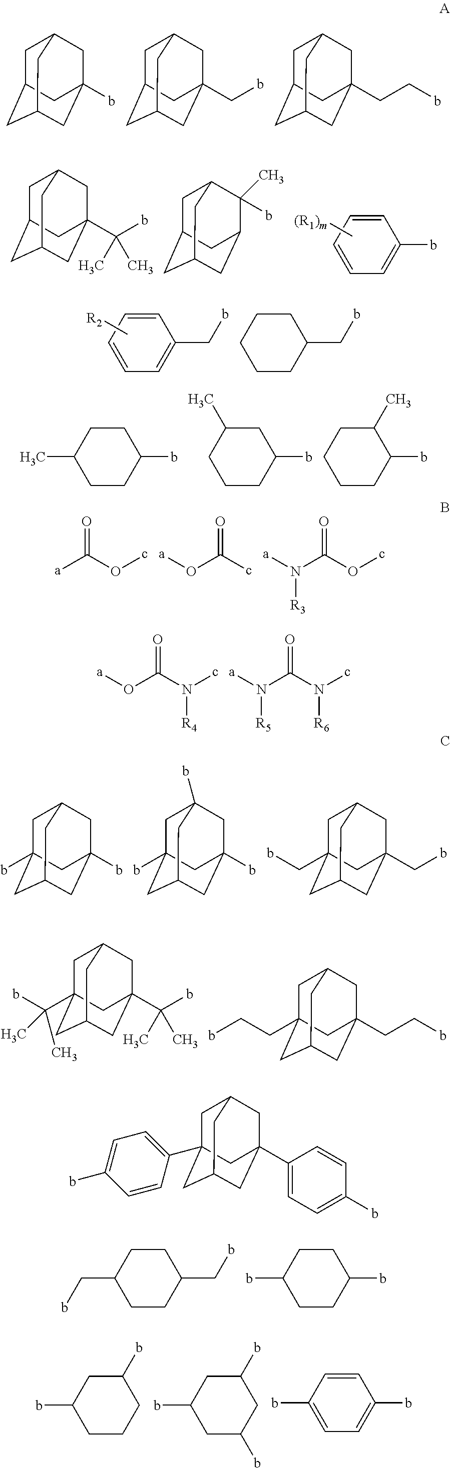 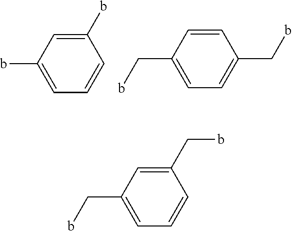
wherein site “a” represents a binding position to structure A; site “b” represents a binding position to structure B; site “c” represents a binding position to structure C; R₁ to R₆ each independently represent a hydrogen atom, a halogen atom, an alkoxy group or an alkyl group; and m represents 1 or 2.

2. The electrophotographic photosensitive member according to claim 1, wherein the content of the polar solvent is 0.1% by mass or more and 1.9% by mass or less based on the gallium phthalocyanine in the gallium phthalocyanine crystal.

3. The electrophotographic photosensitive member according to claim 2, wherein the content of the polar solvent is 0.3% by mass or more and 1.5% by mass or less based on the gallium phthalocyanine in the gallium phthalocyanine crystal.

4. The electrophotographic photosensitive member according to claim 1, wherein the polar solvent is at least one selected from the group consisting of N-methylformamide, N-propylformamide and N-vinylformamide.

5. The electrophotographic photosensitive member according to claim 1, wherein R₁ to R₆ in the formula (1) each independently represent a hydrogen atom or a methyl group.

6. The electrophotographic photosensitive member according to claim 1, wherein B in the formula (1) represents any one of the following structures: 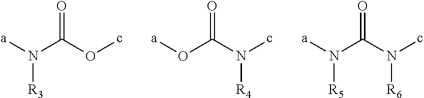
wherein R₃ to R₆ each independently represent a hydrogen atom or an alkyl group; site “a” represents a binding position to structure A; and site “c” represents a binding position to structure C, in the formula (1).

7. The electrophotographic photosensitive member according to claim 1, wherein C in the formula (1) represents any one of the following structures: 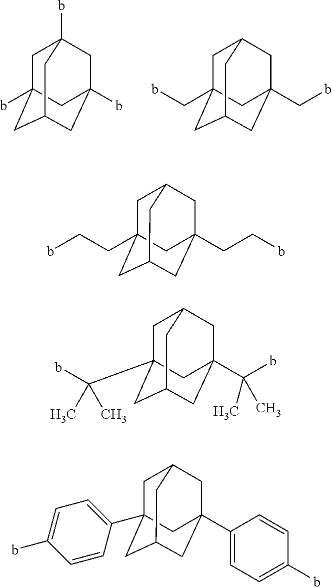
wherein site “b” represents a binding position to structure B in the formula (1).

8. The electrophotographic photosensitive member according to claim 1, wherein the gallium phthalocyanine crystal is a hydroxygallium phthalocyanine crystal or a chlorogallium phthalocyanine crystal.

9. A process cartridge detachably attachable to a main body of an electrophotographic apparatus, wherein the process cartridge integrally supports the electrophotographic photosensitive member according to claim 1, and at least one unit selected from the group consisting of a charging unit that charges a surface of the electrophotographic photosensitive member, a developing unit that develops an electrostatic latent image formed on the surface of the electrophotographic photosensitive member by a toner to form a toner image, and a cleaning unit that removes the toner on the surface of the electrophotographic photosensitive member after the toner image is transferred on a transfer material.

10. An electrophotographic apparatus comprising the electrophotographic photosensitive member according to claim 1, and comprising a charging unit that charges a surface of the electrophotographic photosensitive member, an image exposing unit that irradiates the surface charged of the electrophotographic photosensitive member with image exposing light to form an electrostatic latent image, a developing unit that develops the electrostatic latent image formed on the surface of the electrophotographic photosensitive member by a toner to form a toner image, and a transfer unit that transfers, on a transfer material, the toner image formed on the surface of the electrophotographic photosensitive member.
